(19) United States
(12) Patent Application Publication
(10) Pub. No.: US 2012/0255718 A1
(43) Pub. Date: Oct. 11, 2012

(54) METHOD OF MACHINING CARBON AND GRAPHITE FOAMS

(75) Inventors: James William Klett, Knoxville, TN (US); William Scalia, Dawson, GA (US)

(73) Assignee: UT-Battlelle, LLC, Oak Ridge, TN (US)

(21) Appl. No.: 13/083,913

(22) Filed: Apr. 11, 2011

(51) Int. Cl. F28F 7/00; B26D 3/00

(52) U.S. Cl. 165/185; 83/39

(57) ABSTRACT

A method for fabricating a solid foam article from a solid foam blank includes the steps of forming a pilot hole in the solid foam blank; positioning a chisel in the pilot hole, the chisel having a cutting portion and a shaft; and directing the cutting portion into the pilot hole in a reciprocating motion to remove solid foam material surrounding the pilot hole. A system for forming articles from solid foam blanks and a heat exchange device are also disclosed.

### STATEMENT REGARDING FEDERALLY SPONSORED RESEARCH OR DEVELOPMENT

This invention was made with government support under DE-ACO5-000R22725 awarded by the United States Department of Energy. The Government has certain rights in the invention.

### FIELD OF THE INVENTION

This invention relates to carbon and graphite foams, and more particularly to methods for machining carbon and graphite foams.

### BACKGROUND OF THE INVENTION

The machining of foams, and particularly graphite foams, into heat sinks and other articles is very difficult. In the case of heat sinks, very small fin structures are needed in order to get the best heat transfer. As it has not been practical to mold such items, blanks are first formed and then machined to the proper shape of the article being formed. In recent years certain graphitic foams have become popular because of desirable properties, namely significant thermal conductivity. The act of machining small features in such foams is very difficult and often results in fracture of the fins due to the brittle nature of most graphite foams.

### SUMMARY OF THE INVENTION

A method for fabricating a solid foam article from a solid foam blank includes the steps of forming a pilot hole in the solid foam blank; positioning a chisel in the pilot hole, the chisel having a cutting portion and a shaft; and directing the cutting portion into the pilot hole in a reciprocating motion to remove solid foam material surrounding the pilot hole.

The cutting portion can have an angled wedge portion. A cross-sectional area and shape of the cutting portion can have a cross sectional area and shape of the cross sectional dimensions of a channel to be formed.

A plurality of pilot holes can be formed in the blank, and a plurality of chisels can be simultaneously reciprocated in the pilot holes. The plurality of chisels can be secured to a machine manifold, and the machine manifold can be reciprocated by a driver. The pilot holes can be formed by drilling.

The chisel can form a channel in the foam article. A plurality of chisels can be reciprocated simultaneously to form a plurality of channels in the foam article. The plurality of channels can be formed in a thermally conductive foam article. The thermally conductive foam article can comprise a graphite foam. The stroke length of the reciprocating motion can be between 1/16″ and ¼″, although other dimensions are possible.

A system for forming articles from solid foam blanks can include at least one chisel, the chisel having a cutting portion and a shaft; a driver for reciprocating the chisel; and a device for engaging and securing the solid foam blank in a position to be contacted by the reciprocating chisel, and for advancing the chisel relative to the solid foam blank. The system can further comprising at least one drill for forming a pilot hole in the solid foam blank.

A heat exchange device can have a thermally conductive foam and a plurality of spaced-apart channels formed in the foam. The channels are separated by fins. The thermally conductive foam can be a graphite foam. The width of the fins can be between ½% and 1 times the width of the channels.

### BRIEF DESCRIPTION OF THE DRAWINGS

A fuller understanding of the present invention and the features and benefits thereof will be obtained upon review of the following detailed description together with the accompanying drawings, in which:

FIG. 1 is a front elevation of a finned heat sink.

FIG. 2 is a perspective view of a finned heat sink.

FIG. 3 is a perspective view of a heat sink according to the invention.

FIG. 4 is a front elevation of a heat sink according to the invention.

FIG. 5 is a perspective view of a heat sink at a first stage of production.

FIG. 6 is a perspective view of a heat sink at a second stage of production.

FIG. 7 is a perspective view of a heat sink in an alternative mode of production.

FIG. 8 is a perspective view of a heat sink at a third stage of production.

FIG. 9 is a perspective view of a heat sink at a fourth stage of production.

FIG. 10 is a perspective view of a heat sink at a fifth stage of production.

FIG. 11 is a photograph of an end view of a heat sink produced according to the method of the invention.

FIG. 12 is an enlarged photograph of an end view of a heat sink produced according to the method of the invention.

### DETAILED DESCRIPTION OF THE INVENTION

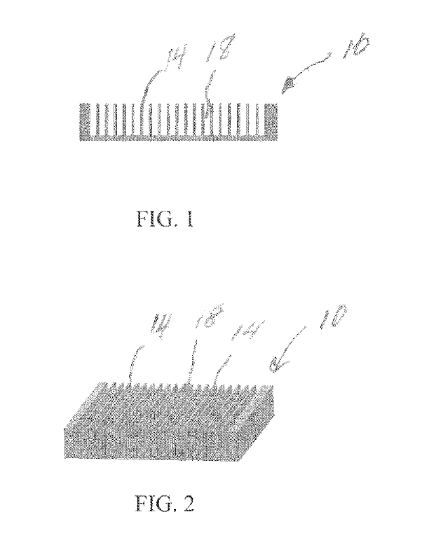

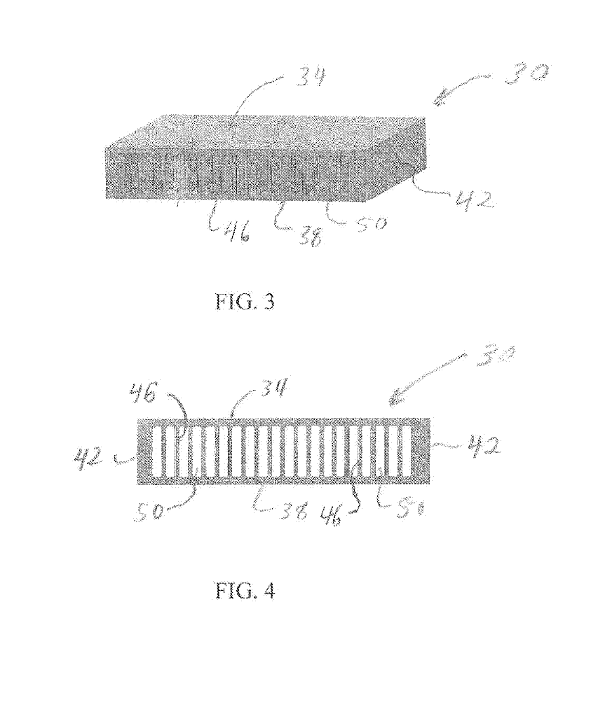

As shown in FIGS. 1-2, a prior art finned heat exchange device 10 can have a plurality of substantially parallel fins 14 defining open channels 18 through which a cooling medium such as air or water is flowed to transfer heat to or from the heat exchange device 10. The width of the channels 18 can be less than ¼″ and the wall thickness of the fins 14 can also be less than ¼″, although other dimensions are possible. In one example, the finned heat sink 10 is 0.4″ tall, and the fins 14 are 0.030″ wide, and the channels 18 are 0.060″ wide. The small dimensions makes the fins 14 unstable and prone to breaking, both during and after fabrication, particularly when the heat exchange device is being fabricated from a graphite foam.

FIGS. 3-4 illustrate a carbon foam heat exchange device 30 according to the invention. The heat exchange device 30 can have many different shapes and sizes, but in the embodiment shown is rectangular with top 34, bottom 38, and sides 42. A plurality of fins 46 are provided and with the top 34 and bottom 38 define enclosed, open-ended channels 50 through which a fluid heat transfer medium can pass. The enclosed channels 50 provide a construction that is less fragile than the traditional machined foams. Further, since both sides can be bonded to heat exchanger tubes with much larger surface area than single fins can provide, there will be better heat transfer from both sides of the fin structure, thus increasing overall heat transfer.

The heat exchange device 30 in one embodiment is 0.4″ tall, the fins are 0.030″ wide, and the enclosed channels 50 are 0.060″ wide, although many other dimensions are possible. For example, the invention can be used to create a device that is 1 inch tall, or 10 inches tall or more, a depth of 1 inch, or 10 inches or more, and with channels that are 0.1″ wide, or 1 inch wide or more. Larger or smaller dimensions are possible. The invention is scalable to create large devices of over 1″ in largest dimension, and to create much smaller devices of 0.1″ in largest dimension, or smaller. If manufactured by traditional techniques, similar designs might require a 2″ long end mill that is 1/16″ diameter and that will not walk during the cutting, which can be difficult in practice to perform. The samples cannot be water jet cut and EDM machining is not viable.

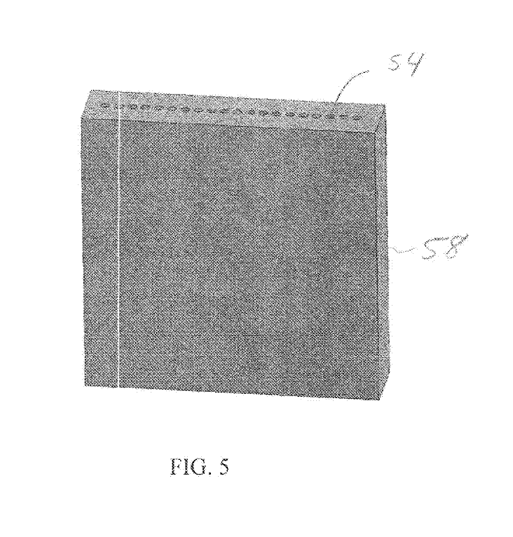

According to the invention, the heat exchange device 30 is formed from a solid foam blank 58 of starting material. The blank can be secured in position by any suitable structure such as a clamp, vise, form for receiving the blank, or the like or alternative structure. A first stage of production is illustrated in FIG. 5. A plurality of pilot holes 54 are formed by any suitable method such as drilling into the solid foam blank 58. The number and location of pilot holes 54 that are formed can vary, and in general should correspond with the number and approximate location of the channels 50 that are desired. The pilot holes 54 are formed through the length of the heat exchange device 30 if open-ended channels are to be formed. If closed-end channels are to be formed, the pilot holes 54 can be drilled to the desired length of the channels. The diameter of the pilot holes can vary and will vary with the dimensions of the channels that are to be formed. In one example, the pilot holes are 1/16″ diameter with a spacing of 0.090″ The pilot hole diameter can be larger, for example 3/32, ⅛, 5/32, or 3/16 in., or smaller, for example 1/32 or 1/64 in. The spacing between pilot holes is similarly variable depending on application and the article that is being fabricated.

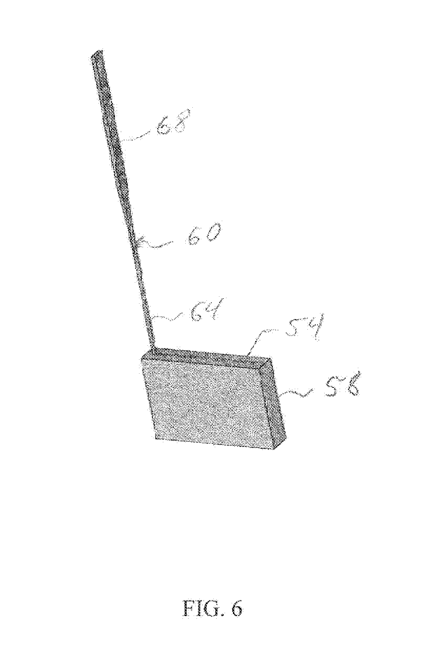

A second stage of production is shown in FIG. 6. A chisel 60 has a cutting portion 64 and a shaft 68. The cutting portion 64 can have an abrasive surface such as a cutting grit or a surface with scribes, protrusions such as saw teeth, or other suitable structure to form an abrasive or cutting surface for removing the solid foam. In one embodiment the cutting portion is in the form of an angled wedge portion. The chisel 60 can have a variety of different shapes, dimensions and materials. The cutting portion 64 should have a hardness that is greater than the hardness of the foam material that is being removed.

The chisel 60 is aligned with and inserted into the pilot hole 54 as shown in FIG. 6 in repeated short strokes. The reciprocation rate and stroke length of the chisel 60 can vary with the nature of the features being formed and the foam material that is used. In one aspect, the stroke length of the reciprocating motion is between 1/16″ and ¼″. Other stroke lengths are possible. Also, the force with which the chisel 60 is driven can vary depending on the foam material. The ends of the chisels 60 can be dimensioned to fit into the open ends of the pilot holes 54. The cutting portion 64 will slowly cut the shape of the channel 50 as desired. The chisel 60 as shown in FIG. 6 is oriented perpendicular the face of the foam, however, the orientation can be in any desired direction to give a desired structure.

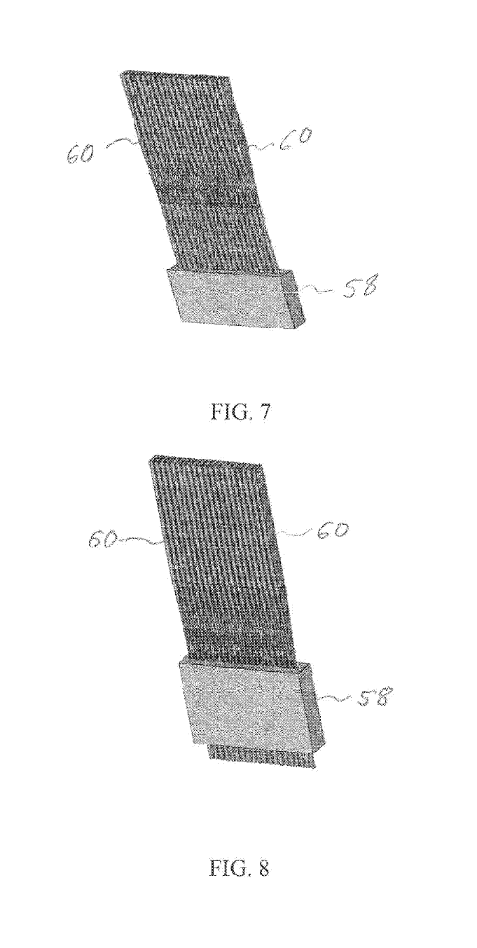

A single chisel 60 can be manipulated relative to the blank 58 to form multiple channels by repositioning either the blank 58 or the chisel 60 after each successive channel is formed. Alternatively, multiple chisels 60 can be provided and used simultaneously to form multiple channels. Such an alternative mode of production is shown in FIG. 7. A plurality of the chisels 60 are inserted into the pilot holes in the blank 58 (FIG. 7). The chisels 60 can be attached to a machine manifold head, which can be custom made or of standard design, that holds the chisels 60 in the desired pattern that corresponds to the pilot holes 54. The chisels 60 are aligned with and lowered into the pilot holes 54.

The ends of the chisels 60 can be positioned into a plate that is spring loaded and fixed to a set of linear bearings. The chisels 60 will remain aligned and straight as they are reciprocated in the pilot holes 54. The plate moves with the press that is moving the chisels 60.

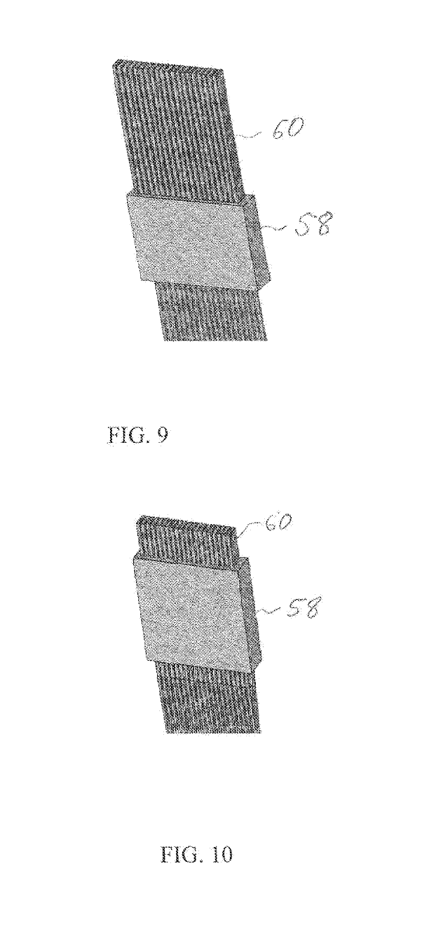

A third stage of production is shown in FIG. 8. The chisels 60 are moved down slightly (for example, 0.05″), and then brought up, in a repetitive movement, very rapidly. As the chisels 60 are moving up and down, the press can slowly move downward and the chisels 60 will advance and slowly cut the desired shape into the foam (FIG. 9). Eventually, the entire cutting portion 64 of the chisels 60 will move through the foam blank 58 and the desired shape would be cut into the foam (FIG. 10).

The invention can be used with many different solid foam materials. Graphitic foams have many desirable properties, particularly thermal conductivity. Examples of such foams, together with methods of making the foams and articles made with or incorporating such foams, can be found in Klett or Klett et al U.S. Pat. Nos. 6,033,506; 6,037,032; 6,261,485; 6,287,375; 6,344,159; 6,387,343; 6,398,994; 6,399,149; 6,430935; 6,656,443; 6,663,842; 6,673,328; 6,780,505; 7,014,151 7,070,755; 7,147,214; 7,157,019; 7,157,059; 7,166,237; and 7,258,836. The disclosure of these patents is hereby incorporated fully by reference.

The invention can also be used with many different types of solid foam materials in addition to graphitic foams. These include polymeric foams such as urethane foams and phenolic foams, and ceramic foams such as alumina, silicon carbide, and other refractory foams. The foams should be porous and brittle such that chiseling will remove foam material. Also, the foam should flex only minimally during chiseling.

The use of different chisel shapes can provide channels having many different shapes and dimensions. A cross sectional area and shape of the cutting portion can have, at least at a part thereof, a cross sectional area and shape of the cross sectional dimensions of a channel to be formed, so that as the chisel is advanced the shape and size of the desired channel will ultimately be cut into the foam. The dimensions and construction of the chisel 60 can vary. In this manner, a multitude of channel shapes and sizes can be cut into the foam. Round holes can be cut, as well as star, C-, cross, and L-shapes, among others. Non-channel features can also be formed.

The invention can be utilized to form many articles from solid foam blanks. These include heat exchange devices for integrated circuits, radiators, and other devices such as cold plates, and other devices that move heat from a point to a fluid. Although the invention has been described with reference to forming channels, other shapes can be imparted into solid foam materials by appropriate manipulation of the chisel orientation and stroke, and/or of the solid foam blank. The pore size and strength of the foam will dictate the smallest size of features that can be formed in the foam. In the case of graphitic foams, features 0.020″ or larger can be formed.

### EXAMPLES

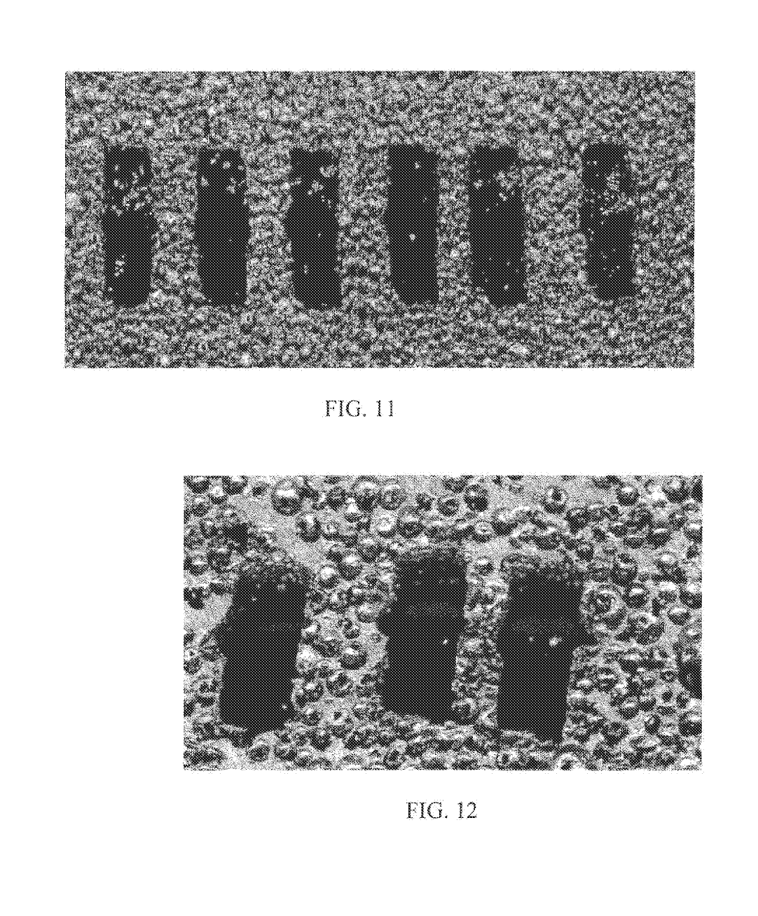

In one example, a flat file with a 1/16″ cross section×0.25″ tall was used according to the invention to cut a series of holes in manufactured Koppers® 1-1 Foams (Pittsburgh Pa.), as shown in FIG. 11. It can be seen that the edges of the channels are straight with only a slight deformation due to the pilot hole being slightly larger than the file.

In another example, a block of foam that was partially filled with a phenolic resin and cured at 300° C., was cut using this method. It can be seen in FIG. 12 that the edges are straighter than the raw foam example of FIG. 11 above. The fin width could be as small as ½ that of the cut hole dimension of 1/16″, and could be equal to the cut hole dimension or greater. The method can therefore be used to cut foams into an ideal finned heat sink shape.

In the foregoing detailed description of the preferred embodiments, reference is made to the accompanying drawings, which form a part hereof and within which are shown by way of illustration the practice of specific embodiments of apparatus and methods of the invention. It is to be understood that other embodiments may be utilized, and that structural changes may be made and processes may vary in other embodiments.

We claim:

1. A method for fabricating a solid foam article from a solid foam blank, comprising the steps of:
forming a pilot hole in the solid foam blank;
positioning a chisel in the pilot hole, the chisel having a cutting portion and a shaft;
directing the cutting portion into the pilot hole in a reciprocating motion to remove solid foam material surrounding the pilot hole.

2. The method of claim 1, wherein the cutting portion comprises an angled wedge portion.

3. The method of claim 1, wherein a cross sectional area and shape of a part of the cutting portion has a cross sectional area and shape of the cross sectional dimensions of a channel to be formed.

4. The method of claim 1, wherein a plurality of pilot holes are formed in the blank and a plurality of chisels are simultaneously reciprocated in the pilot holes.

5. The method of claim 4, wherein the plurality of chisels is secured to a machine manifold, and the machine manifold is reciprocated by a driver.

6. The method of claim 1, wherein the pilot holes are formed by drilling.

7. The method of claim 1, wherein the chisel forms a channel in the foam article.

8. The method of claim 1, wherein a plurality of chisels are reciprocated simultaneously to form a plurality of channels in the foam article.

9. The method of claim 1, wherein a plurality of channels are formed in a thermally conductive foam article.

10. The method of claim 9, wherein the thermally conductive foam article is a graphite foam.

11. The method of claim 1, wherein the stroke length of the reciprocating motion is between 1/16″ and ¼″.

12. A system for forming articles from solid foam blanks, comprising:
at least one chisel, the chisel having a cutting portion and a shaft;
a driver for reciprocating the chisel; and,
a device for engaging and securing the solid foam blank in a position to be contacted by the reciprocating chisel, and for advancing the chisel relative to the solid foam blank.

13. The system of claim 12, further comprising at least one drill for forming a pilot hole in the solid foam blank.

14. A heat exchange device comprising a thermally conductive foam and a plurality of spaced-apart channels formed in the foam, the channels being separated by fins.

15. The heat exchange device of claim 14, wherein the thermally conductive foam is a graphite foam.

16. The heat exchange device of claim 1, wherein the width of the fins is between ½ and 1 times the width of the channels.
